(19) United States
(12) Patent Application Publication
(10) Pub. No.: US 2016/0082548 A1
(43) Pub. Date: Mar. 24, 2016

(54) Laser Beam Splitting and Angle Adjusting Device

(71) Applicant: WECON AUTOMATION CORP., Hsinchu City (TW)

(72) Inventors: CHING TSUNG CHANG, Hsinchu City (TW); CHAO CHING WU, Hsinchu City (TW)

(21) Appl. No.: 14/566,707

(22) Filed: Dec. 10, 2014

(30) Foreign Application Priority Data
Sep. 19, 2014 (TW) 103132403

(51) Int. Cl. B23K 26/362; B23K 26/06; B23K 26/067; G02B 26/10

(52) U.S. Cl. CPC B23K 26/362; G02B 26/10; B23K 26/0648; B23K 26/0652; B23K 26/0673

(57) ABSTRACT

The present invention relates to a laser beam splitting and angle adjusting device. The device comprises a design of a multibeam module disposed between a plurality of laser units and a refractor to allow light beams emitted out from the plurality of laser units being modulated by the multibeam module so as to perform scan photolithography on photomask patterns. Different cutting purposes can be achieved through adjusting an arrangement of light beams in order to accomplish effects including deepening depths of cutting, and adjusting or controlling a size of groove widths of groove cutting, and so on.

### BACKGROUND OF THE INVENTION

1. Field of the Invention

The present invention relates to a laser beam splitting and angle adjusting device, and especially to a device comprising a design of a multibeam module to allow light beams emitted out from a plurality of laser units being modulated by the multibeam module so as to accomplish effects including performing scan photolithography on photomask patterns, and so on. The device is applicable to precision wafer operation machines, mask etching machines or similar machine structures.

2. The Related Arts

Owing to advancing development of technology products, these technology products become integrated with multiple functions so that semiconductor chips or wafers required in these technology products tend to become also more and more precise. A mold which produces integrated circuit (IC) chips and optoelectronic elements is called as a photomask. When an IC design company designs a chip circuit diagram, a photomask company is required to make a photomask based on the circuit diagram. The circuit diagram and its related photomask will be sent to a wafer fabrication factory, an optoelectronic element company or a packaging and testing factory for wafer producing, packaging and testing in order to make a plurality of IC chips or optoelectronic elements.

Currently, integrated circuit manufacturing processes are in the deep sub-nanometer generation. During manufacturing processes of semiconductor chips or wafers, optical lithography technology becomes more and more important. Optical lithography technology, i.e., photolithography or photoetching, is a precise surface processing technology of combining diagram/graphic copying and chemical corrosion. The purpose of optical lithography is to chemically etch a corresponding or complementary geometric graph of masks on silicon dioxide or metal films. ArF lasers with a wavelength of 1933 mm are mainly used in the currently adopted optical lithography technology. Optical lithography technology is a process having complex engineering production steps, which comprise cleaning, photoresist applying, exposure and developing, drying, etching and photoresist film removal, and so on. Not only equipment required in performing optical lithography technology is characterized by larger investment and higher maintenance cost, but also a large amount of chemicals is required to perform optical lithography technology. As a result, problematic issues such as much higher manufacturing costs and much longer producing hours, etc., are easily caused. Particularly, these problematic issues are much more severe for large sized touch screens and may easily cause declination of production yield rates.

In performing conventional technology of optical lithography, a single light beam is utilized for cutting. However, it is prone to failing to achieve production of preset cutting widths or depths since the corresponding photomask has a smaller cut groove when the single light beam is used to cut.

In view of the above drawbacks, the named inventor(s) of the present invention makes painstaking efforts to research and study, design and fabricate, and expects to provide a laser beam splitting and angle adjusting device which is able to deepen cutting depths or control groove sizes and is easily to be operated and assembled in order to provide users with convenience. The above is inventive motives of the named inventors of the present invention to research and develop the present invention.

### SUMMARY OF THE INVENTION

A main object of the present invention is to provide a laser beam splitting and angle adjusting device. The device comprises a design of a multibeam module disposed between a plurality of laser units and a refractor. Light beams emitted out from the plurality of laser units are modulated by the multibeam module so as to perform scan photolithography on the photomask patterns. Different cutting purposes can be achieved through adjusting an arrangement of light beams in order to accomplish effects including deepening depths of cutting, adjusting or controlling a size of groove widths of groove cutting, and so on. Thus, practicability and convenience of the whole device is enhanced.

Another object of the present invention is to provide another laser beam splitting and angle adjusting device. A light beam emitted out from the plurality of laser units is a single light beam, and is modulated by the multibeam module and turns into multi-beams to achieve a purpose of pre-cutting or repeatedly cutting the photomask patterns. As a result, deepening cutting efficiency of photomask patterns is achieved and practicability of the entire device is further enhanced.

The other object of the present invention is to provide another laser beam splitting and angle adjusting device. A single light beam emitted out from the plurality of laser units is modulated by the multibeam module and turns into multi-beams, and through corresponding rotating adjustment of the multibeam module, the multi-beams are modulated in a straight or oblique beam arrangement to achieve purposes of adjusting and controlling a size of groove widths of groove cutting of cutting photomask patterns. As a result, efficiency of adjusting and controlling the size of groove widths of groove cutting of the photomask patterns is achieved, and practicability of the entire device is further enhanced.

To achieve the above objects, the laser beam splitting and angle adjusting device of the present invention comprises a plurality of laser units, a refractor and a convergent lens. Light beams emitted out from the plurality of laser units are refracted by the refractor toward the convergent lens. The present invention is characterized that a multibeam module is disposed between the plurality of laser units and the refractor, and the light beams emitted out from the plurality of laser units are modulated by the multibeam module in order to perform scan photolithography.

In order to describe the present invention for better understanding of characteristics, features and technical content, the present invention is explained via the following detailed illustrative embodiments and the attached drawings. However, the attached drawings are only provided for reference and explanation, and are not intended to limit the present invention.

### BRIEF DESCRIPTION OF THE DRAWINGS

FIG. 1 is a schematic equipment arrangement diagram of a laser beam splitting and angle adjusting device in accordance with an embodiment of the present invention.

FIG. 2 is a schematic equipment arrangement diagram of the laser beam splitting and angle adjusting device of FIG. 1 in accordance with an embodiment of the present invention when laser beams are in a straight beam arrangement; and

FIG. 3 is a schematic equipment arrangement diagram of the laser beam splitting and angle adjusting device of FIG. 1 in accordance with an embodiment of the present invention when laser beams are in an oblique beam arrangement.

### DETAILED DESCRIPTION OF PREFERRED EMBODIMENT

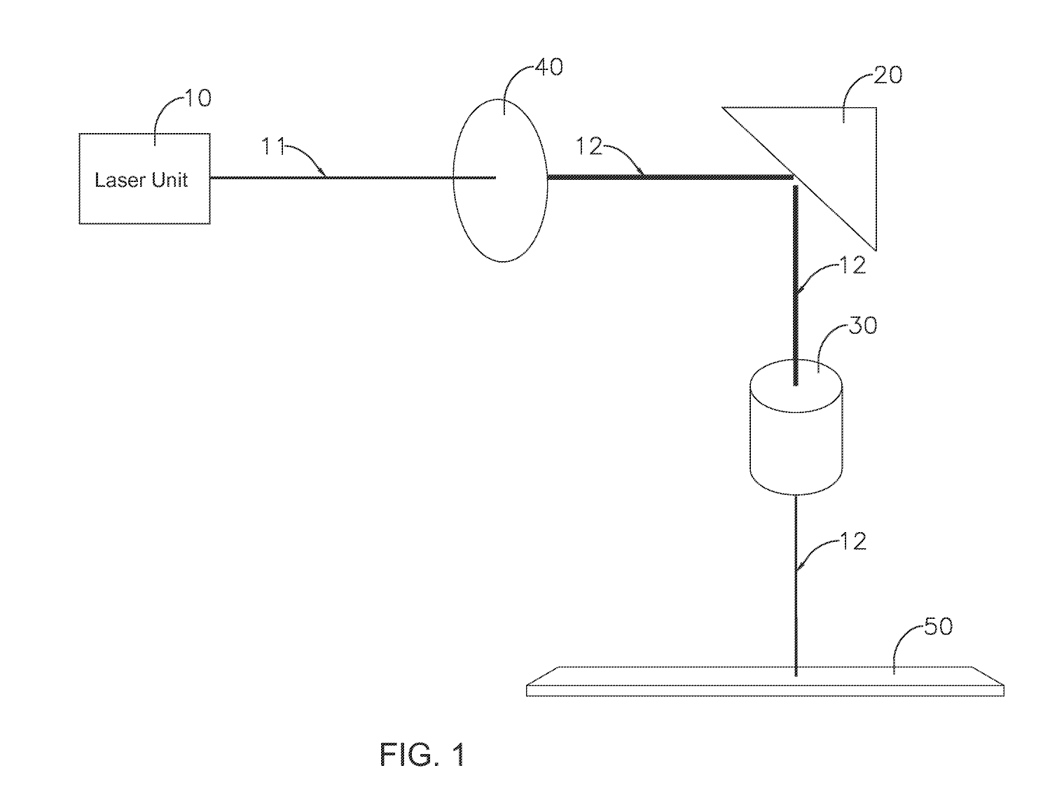

FIGS. 1 to 3 shows schematic equipment arrangement diagrams of a laser beam splitting and angle adjusting device in accordance with an embodiment of the present invention. The laser beam splitting and angle adjusting device in accordance with a preferable embodiment of the present invention is applied to precision wafer operation machines, mask etching machines or similar structural machines. The laser beam splitting and angle adjusting device of the present invention comprises a plurality of laser units 10, a refractor 20 and a convergent lens 30. The plurality of laser units 10 are able to emit a light beam 11 to pass through the refractor 20 for being refracted and to be transmitted toward the convergent lens 30. The single light beam 11 emitted from the plurality of laser units 10 is a laser beam.

A multibeam module 40 (as shown in FIG. 1) in accordance with the present invention is disposed and provided between the plurality of laser units 10 and the refractor 20. Accordingly, the light beam 11 emitted from the plurality of laser units 10 is transmitted to and enters the multibeam module 40 first. Subsequently, the multibeam module 40 modulates the transmitted light beam 11 into multi-beams 12, and the modulated multi-beams 12 are transmitted to the convergent lens 30 through refraction of the refractor 20. The convergent lens 30 is located above a wafer surface 50, and various photomask patterns 51 are disposed and laid on the wafer surface 50. Herein, the photomask patterns 51 are indicated as a circuit diagram of an integrated circuit. The multi-beams 12 emitted out from the convergent lens 30 are adopted to perform scan photolithography on the wafer surface 50.

It is easy to generate slag (not shown) on the wafer surface when the multi-beams 12 transformed by the multibeam module 40 from the light beam 11 emitted out of the laser unit 10 and entering the multibeam module 40 is adopted to perform scan photolithography on the wafer surface 50. As a result, a protecting layer is disposed on the wafer surface 50 in advance for protection. After wafer cutting, the protecting layer on the wafer surface 50 is cleaned and removed by pure water.

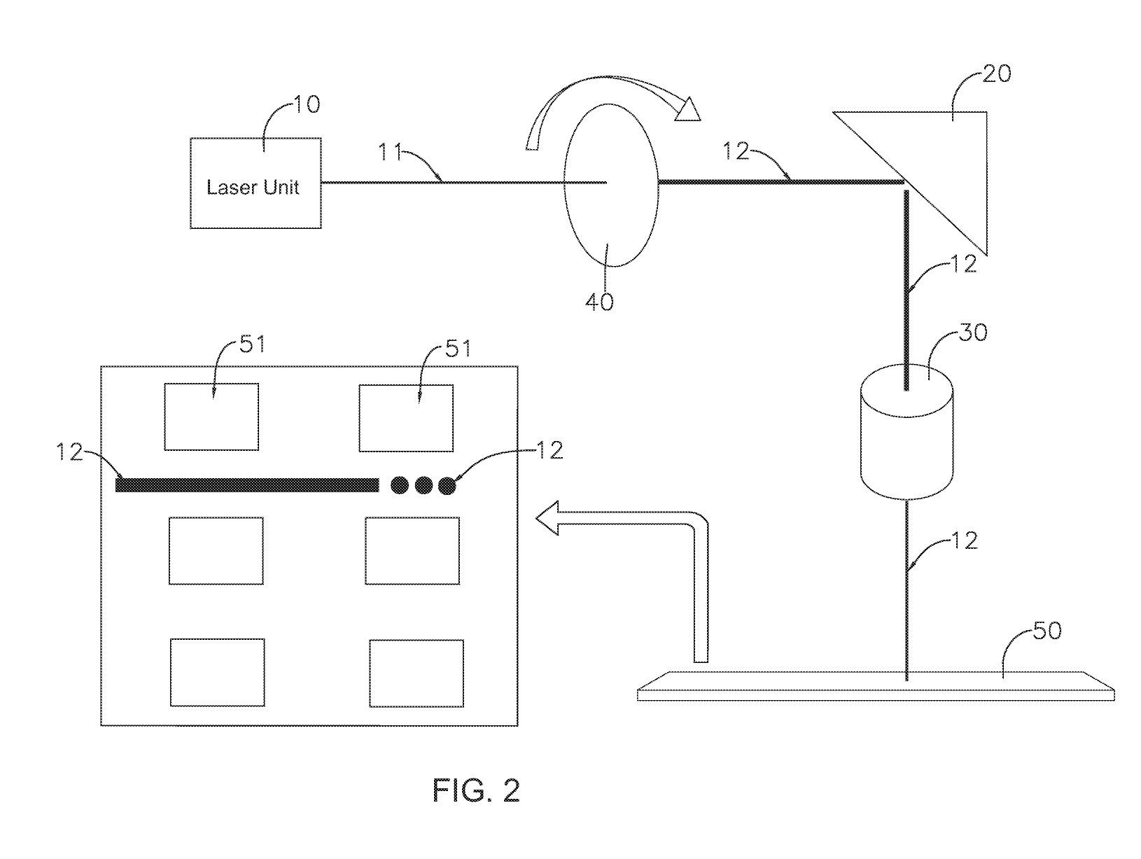

Moreover, a first embodiment of the present invention (as shown in FIG. 2) is provided as follows. When the photomask patterns 51 are required to be cut deeper, the light beam 11 emitted out from the plurality of laser units 10 is modulated and turns into the multi-beams 12 through corresponding rotating adjustment of the multibeam module 40 in order to modulate the multi-beams 12 in a straight beam arrangement. In the present invention, the multi-beams 12 emitted out from the multibeam module 40 are exemplified to have three light beams therein (In other embodiments, the multi-beams 12 emitted out from the multibeam module 40 can have a plurality of light beams, and are not limited by presentation of drawings of the present invention). The multi-beams 12 in the straight beam arrangement are transmitted collectively to the refractor 20 and are then refracted by the refractor 20 toward the convergent lens 30. The multi-beams 12 transmitted out from the convergent lens 30 are directly emitted onto the wafer surface 50 in order to be able to deepen a depth of cutting so that the purpose of pre-cutting and cutting repeatedly can be achieved.

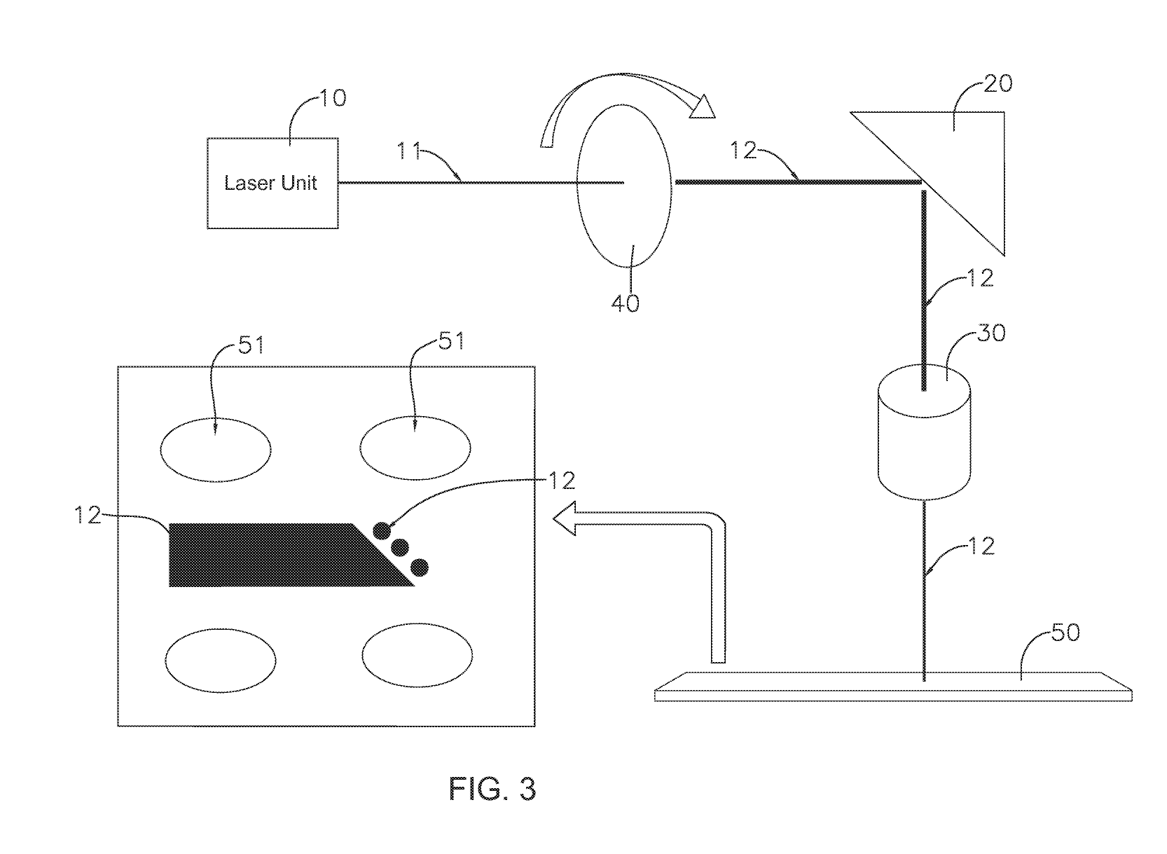

Additionally, a second embodiment of the present invention (as shown in FIG. 3) is provided as follows. When the photomask patterns 51 is required to cut a groove, the light beam 11 emitted out from the plurality of laser units 10 is modulated and turns into the multi-beams 12 through corresponding rotating adjustment of the multibeam module 40 in order to modulate the multi-beams 12 in an oblique beam arrangement. In the present invention, the multi-beams 12 emitted out from the multibeam module 40 are exemplified to have three light beams therein (In other embodiments, the multi-beams 12 emitted out from the multibeam module 40 can have a plurality of light beams, and are not limited by presentation of the drawings of the present invention). The multi-beams 12 in the oblique beam arrangement are transmitted to the refractor 20 and are then refracted by the refractor 20 toward the convergent lens 30. The multi-beams 12 transmitted out from the convergent lens 30 are directly emitted onto the wafer surface 50 in order to be able to generate a groove width for groove cutting, and via the corresponding rotating adjustment of the multibeam module 40, to adjust and control a size of the groove width of groove cutting (The groove width of groove cutting is set according to different products) so that the purpose of grooving can be achieved.

With a designed feature of installing the multibeam module 40 between the plurality of laser units 10 and the refractor 20, the light beam 11 emitted out from the plurality of laser units 10 is modulated by the multibeam module 40 so as to perform scan photolithography on the photomask patterns 51. Different cutting purposes can be achieved through adjusting an arrangement of the multi-beams 12 in order to accomplish effects including deepening depths of cutting, or adjusting and controlling a size of groove widths of groove cutting, and so on. Thus practicability and convenience of the entire device can be enhanced.

As described in details above, any person skilled in this art who is familiar with the present invention can easily understand that the above mentioned objects can be indeed achieved by the present invention. The present patent application is hereby filed for a patent to be granted.

Although only the preferred embodiments of the present invention are described as above, the practicing scope of the present invention is not limited to the disclosed embodiments. It is understood that any simple equivalent changes or adjustments to the present invention based on the following claims of the present invention and the content of the above invention description may be still covered within the claimed scope of the following claims of the present invention.

What is claimed is:

1. A laser beam splitting and angle adjusting device, comprising a plurality of laser units, a refractor and a convergent lens, the plurality of laser units emitting a light beam being refracted by the refractor toward the convergent lens, wherein a multibeam module is disposed between the plurality of laser units and the refractor, and the light beam emitted out from the plurality of laser units is modulated by the multibeam module in order to perform scan photolithography.

2. The laser beam splitting and angle adjusting device as claimed in claim 1, wherein the light beam emitted out from the plurality of laser units is further modulated by the multibeam module to generate multi-beams, and the multi-beams are modulated to adjust a beam arrangement angle thereof as in a straight beam arrangement through corresponding rotating adjustment of the multibeam module so as to deepen cutting depths.

3. The laser beam splitting and angle adjusting device as claimed in claim 1, wherein the light beam emitted out from the plurality of laser units is further modulated by the multibeam module to generate multi-beams, and the multi-beams are modulated to adjust a beam arrangement angle thereof as in an oblique beam arrangement through corresponding rotating adjustment of the multibeam module so as to control a groove width of groove cutting.

4. The laser beam splitting and angle adjusting device as claimed in claim 1, wherein the convergent lens is located above a wafer surface, and a photomask pattern is further disposed and laid on the wafer surface.

5. The laser beam splitting and angle adjusting device as claimed in claim 1, wherein the light beam emitted out from the plurality of laser units is a laser beam.
